(19) United States
(12) Patent Application Publication
(10) Pub. No.: US 2022/0370288 A1
(43) Pub. Date: Nov. 24, 2022

(54) HUMAN BODY STIMULATION UNIT AND HUMAN BODY STIMULATION DEVICE INCLUDING HUMAN BODY STIMULATION UNIT

(71) Applicant: HUTECH INDUSTRY CO., LTD., Cheonan-si (KR)

(72) Inventors: Hwa Don JU, Gimpo-si (KR); Sung Don KWON, Gimpo-si (KR)

(21) Appl. No.: 17/818,280

(22) Filed: Aug. 8, 2022

Related U.S. Application Data
(63) Continuation of application No. PCT/KR2022/001213, filed on Jan. 24, 2022.

(30) Foreign Application Priority Data
Feb. 2, 2021 (KR) 10-2021-0014994

(51) Int. Cl. A61H 23/02

(52) U.S. Cl. CPC A61H 23/0236; A61H 2201/0138; A61H 2201/1676

(57) ABSTRACT

A human body stimulation unit and a human body stimulation device including the human body stimulation unit. A human body stimulation unit provides a sonic vibration massage to a body of a user. The sonic vibration module includes a housing, a sonic vibration generator that generates sonic vibration inside the housing, and a head connected to the sonic vibration generator and configured to transmit the generated sonic vibration to the body of the user in order for the sonic vibration massage. The housing partially surrounds the head to expose a portion of an upper portion of the head from the housing, and the exposed portion of the head is formed such that the head comes into contact with the body of the user even when the sonic vibration module is positioned at a maximum rotation angle in the preset rotation angle range.

### CROSS-REFERENCE TO RELATED APPLICATIONS

This is a bypass continuation application of International PCT Application No. PCT/KR2022/001213, filed on Jan. 24, 2022, which claims priority to Republic of Korea Patent Application No. 10-2021-0014994, filed on Feb. 2, 2021, which are incorporated by reference in their entirety.

### TECHNICAL FIELD

The present invention relates to a human body stimulation unit and a human body stimulation device including the human body stimulation unit, and more particularly, to a human body stimulation unit for providing a sonic vibration massage, and a human body stimulation device including the human body stimulation unit.

### BACKGROUND ART

As the quality of life is improved, an interest in massages that assist in relieving fatigue and stress is increasing. Recently, among the massages, due to a soft massage feeling, a demand for a sonic vibration massage, which transmits sonic vibrations to a body part to carefully massage the body part, is increasing.

Thus, there is a human stimulation device to which the conventional device for generating sonic vibrations is applied, but in such a massage device, the device for generating sonic vibration is not optimized for providing a massage, and thus there is a problem in that, when a massage is provided, sonic vibration is not properly transmitted to a body part of a user.

Therefore, there is a need to develop a technology for effectively providing sonic vibration to a user when a sonic vibration massage is provided.

### SUMMARY

The present invention is directed to providing a human body stimulation unit for providing general massages such as a tapping massage and a kneading massage along with a sonic vibration massage to a body part of a user, and a human body stimulation device including the human body stimulation unit.

The present invention is directed to providing a human body stimulation unit using a head for transmitting sonic vibration, and a human body stimulation device including the human body stimulation unit.

The present invention is directed to providing a human body stimulation unit in which an exposure degree of a head for transmitting sonic vibration is designed, and a human body stimulation device including the human body stimulation unit.

Technical solutions of the present application may not be limited to the above, and other technical solutions which are not described herein should be clearly understood by those skilled in the art, to which the present invention belongs, from the present specification and the accompanying drawings.

According to one embodiment of the present invention, a human body stimulation unit, which provides a sonic vibration massage to a body of a user according to one embodiment, includes a sonic vibration module configured to provide the sonic vibration massage, an arm connected to one end portion of the sonic vibration module to support the sonic vibration module, and a driving unit which drives the arm to move the sonic vibration module within a preset rotation angle range, wherein the sonic vibration module includes a housing, a sonic vibration generator configured to generate sonic vibration inside the housing, and a head connected to the sonic vibration generator and configured to transmit the generated sonic vibration to the body of the user in order for the sonic vibration massage, the housing partially surrounds the head to expose a portion of an upper portion of the head from the housing, and the exposed portion of the head is formed such that the head comes into contact with the body of the user even when the sonic vibration module is positioned at a maximum rotation angle in the preset rotation angle range.

According to one embodiment of the present invention, a chair-type human body stimulation device, a bed-type human body stimulation device, or a sofa-type human body stimulation device includes the human body stimulation unit.

The objects of the present invention are not limited to the above-described objects, and other objects which are not described herein should be clearly understood by those skilled in the art, to which the present invention belongs, from the following detailed description and the accompanying drawings.

According to one embodiment of the present application, general massages such as a tapping massage and a kneading massage are provided along with a sonic vibration massage to a body part of a user, thereby providing various massages to the user.

According to one embodiment of the present application, it is possible to effectively provide a sonic vibration massage to a body part of a user using a head that transmits sonic vibration.

According to one embodiment of the present application, an exposure degree of a head for transmitting sonic vibration is designed, thereby transmitting sonic vibration to a body part of a user within an entire range in which a sonic vibration module moves.

Effects of the present application may not be limited to the above, and other effects which are not described herein should be clearly understood by those skilled in the art, to which the present invention belongs, from the present specification and the accompanying drawings.

### BRIEF DESCRIPTION OF DRAWINGS

FIG. 1 is a view illustrating a human body stimulation device according to one embodiment.

FIG. 2 is a front view of a human body stimulation unit according to one embodiment.

FIG. 3 is a side view of the human body stimulation unit according to one embodiment.

FIG. 4 shows diagrams illustrating movement of a sonic vibration module according to one embodiment.

FIG. 5 is a view illustrating a human body stimulation unit according to another embodiment.

FIG. 6 is a view illustrating a sonic vibration module according to one embodiment.

FIG. 7 is a view illustrating a head and a sonic vibration generator of the sonic vibration module according to one embodiment.

FIG. 8 is an exploded perspective view illustrating the head and the sonic vibration generator according to one embodiment.

FIG. 9 is a cross-sectional view illustrating the head and the sonic vibration generator according to one embodiment.

FIG. 10 is a front view illustrating the sonic vibration module according to one embodiment.

FIG. 11 shows diagrams for describing a maximum exposure degree of the head of the sonic vibration module according to one embodiment.

FIG. 12 shows views for describing that whether the head is in contact with the body is changed according to an exposure degree of the head according to one embodiment.

FIGS. 13 and 14 are diagrams for describing a relationship between a rotation angle at which the sonic vibration module moves and a solid angle of an exposed portion of the head according to one embodiment.

### DETAILED DESCRIPTION

Embodiments described in the present specification are made to clearly explain the scope of the present invention to those having ordinary skill in the art and are not intended to limit the present invention. It should be interpreted that the present invention may include substitutions and modifications within the technical scope of the present invention.

The terms used in the present specification are selected from general terms, which are widely used currently, based on functions of components according to the embodiment of the present invention, and may have meanings varying according to the intentions of those skilled in the art, the custom in the field of art or advent of new technology. If a specific term is used with a specific meaning, the meaning of the term will be described specifically. Accordingly, the terms used in the present specification should not be defined as simple names of the components but should be defined based on the actual meaning of the terms and the whole context throughout the present specification.

The accompanying drawings are to facilitate the explanation of the present invention and the shape in the drawings may be exaggerated for the purpose of convenience of explanation, so the present invention should not be limited to the drawings.

In addition, the details of the generally known function and structure, which make the subject matter of the present invention unclear, will be omitted.

According to one aspect of the present specification, there may be provided a human body stimulation unit for providing a sonic vibration massage to a body of a user, the human body stimulation unit including a sonic vibration module configured to provide the sonic vibration massage, an arm connected to one end portion of the sonic vibration module to support the sonic vibration module, and a driving unit which drives the arm to move the sonic vibration module within a preset rotation angle range, wherein the sonic vibration module includes a housing, a sonic vibration generator configured to generate sonic vibration inside the housing, a head connected to the sonic vibration generator and configured to transmit the generated sonic vibration to the body of the user in order for the sonic vibration massage, the housing partially surrounds the head to expose a portion of an upper portion of the head from the housing, and the exposed portion of the head is formed such that the head comes into contact with the body of the user even when the sonic vibration module is positioned at a maximum rotation angle in the preset rotation angle range.

According to one embodiment, the exposed portion of the head may have a solid angle that is greater than the maximum rotation angle in the preset rotation angle range, and the solid angle may be defined as an angle between a central axis of the head and an imaginary line formed between a central point of the upper portion of the head and a point at which the exposed portion starts to be exposed from the housing.

According to one embodiment, while the sonic vibration is generated, the solid angle may be changed between a minimum solid angle and a maximum solid angle, and the minimum solid angle may be set to be greater than the maximum rotation angle such that the head is in continuous contact with the body of the user while the sonic vibration is generated.

According to one embodiment, the exposed portion may be formed based on an amplitude of the sonic vibration.

According to one embodiment, the length of the exposed portion may be less than a maximum amplitude of the sonic vibration massage.

According to one embodiment, a lower portion of the head may be connected to the sonic vibration generator and transmits the sonic vibration generated from the sonic vibration generator to the upper portion of the head, and the upper portion of the head may apply the received sonic vibration to the body of the user.

According to one embodiment, the upper portion of the head may be formed in a shape having a round surface including a spherical shape or a hemispherical shape

According to one embodiment, a front surface portion of the housing may have a round surface.

According to one embodiment, the arm may include an upper portion and a lower portion which move in conjunction with each other, a massage ball or the sonic vibration module may be installed at the upper portion, and the sonic vibration module may be installed at the lower portion.

According to one embodiment, the sonic vibration module installed at the lower portion may be installed downward at a certain angle from the arm.

According to one embodiment, the certain angle may be related to an angle at which the lower portion is inclined when the sonic vibration module installed at the lower portion is moved forward to or backward from the body of the user by the driving part.

According to one embodiment, the certain angle may be in a range of 5° to 20°.

According to one embodiment, there may be provided a chair-type human body stimulation device, a bed-type human body stimulation device, or a sofa-type human body stimulation device including at least one human body stimulation unit.

Hereinafter, a human body stimulation device may refer to various types of devices for providing a function of providing stimulation to a user. There may be various purposes of providing stimulation to the user. For example, the human body stimulation device may provide stimulation to the user in order for various purposes such as a massage purpose, a medical purpose, a pain relief purpose, a fatigue recovery purpose, a rehabilitation purpose, a health improvement purpose, and a weight training purpose. In addition, according to the purpose, the human body stimulation device may include various devices such as a massage device, a medical device, a pain relief device, a fatigue recovery device, a rehabilitation device, a health improvement device, and a weight training device.

In the present specification, for convenience of description, the present invention and various embodiments will be described based on the massage device among various human body stimulation devices. However, the present invention is not limited to the massage device, and of course, descriptions of the present invention may be applied to the various human body stimulation devices other than the massage device.

Hereinafter, a human body stimulation operation may refer to an operation of providing stimulation to the user. As described above, as a purpose of stimulating the user, there are various purposes such as a massage purpose, a medical purpose, a pain relief purpose, a fatigue recovery purpose, a rehabilitation purpose, a health improvement purpose, and a weight training purpose. In addition, according to the purpose, the human body stimulation operation may also include various operations such as a massage operation, a medical operation, a pain relief operation, a fatigue recovery operation, a rehabilitation operation, a health improvement operation, and a weight training operation.

In the present specification, for convenience of description, the present invention and various embodiments will be described based on the massage operation among various human body stimulation operations. However, the present invention is not limited to the massage operation, and of course, descriptions of the present invention may be applied to the various human body stimulation operations other than the massage operation.

Hereinafter, the massage operation may refer to an operation of providing stimulation to the user in order to facilitate body metabolism. In one embodiment, the massage operation may include a motion massage, a vibration massage (motor vibration massage or sonic vibration massage), an air massage, a thermal massage, and a multimodal massage. In addition, the motion massage, the vibration massage (motor vibration massage or sonic vibration massage), the air massage, the thermal massage, and the multimodal massage may be expressed as a motion stimulation operation, a vibration stimulation operation (motor vibration stimulation operation or sonic vibration stimulation operation), an air stimulation operation, a thermal stimulation operation, and a multimodal stimulation operation.

In addition, as described above, for convenience of description, the present invention will be described based on a massage, and the description of the present invention is not limited to a massage device and a massage operation. For example, in the present specification, of course, a massage device, a massage unit, and a massage member may be expressed as a stimulation device, a stimulation unit, and a stimulation member.

In addition, as described above, for convenience of description, the present invention will be described based on a massage, and the description of the present invention is not limited to a massage device and a massage operation. For example, in the present specification, of course, the motion massage member, the vibration massage member (motor vibration massage member or sonic vibration massage member), the air massage member, and the thermal massage member may be expressed as a motion stimulation member, a vibration stimulation member (motor vibration stimulation member or sonic vibration massage member), air stimulation member, and a thermal stimulation member.

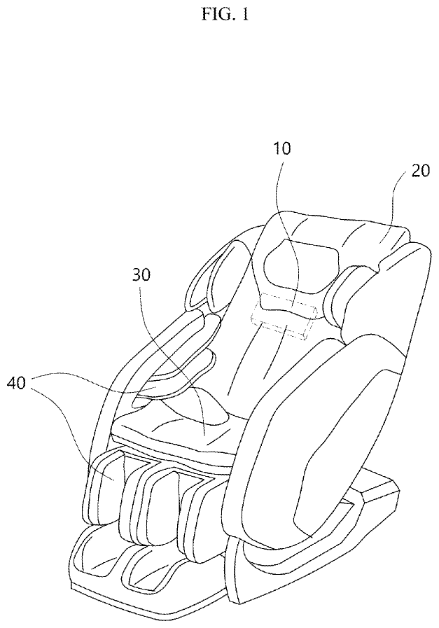

FIG. 1 is a view illustrating a human body stimulation device 1 according to one embodiment.

Referring to FIG. 1, the human body stimulation device 1 according to one embodiment may be implemented as a chair-type human body stimulation device 1. For example, the human body stimulation device 1 may be a massage chair which includes a backrest 20 including a human body stimulation unit 10, a seat 30, and an arm/leg unit 40. However, the present invention is not limited thereto, and the human body stimulation device 1 may be implemented as other types such as a bed type and a sofa type other than a chair type. For example, the human body stimulation device 1 according to one embodiment may be a bed-type device in which the human body stimulation unit 10 is provided in a mattress.

The human body stimulation device 1 according to one embodiment may include massage applicators for massaging a body of a user. For example, the human body stimulation device 1 may include massage applicators such as air cells, rollers, and acupressure protrusions in the backrest 20, the seat 30, and/or the arm/leg unit 40.

The human body stimulation device 1 according to one embodiment may massage the body of the user through the human body stimulation unit 10. For example, the human body stimulation device 1 may massage the body of the user through the human body stimulation unit 10 installed inside the backrest 20. For example, the human body stimulation unit 10 may provide various stimuli for a body massage to a body, such as tapping, kneading, and pressing the body. Specifically, the human body stimulation unit 10 may drive an arm 200 through the driving unit 100 to physically massage a body through a massage ball 400 or a sonic vibration module 300 disposed at one end portion of the arm 200.

In addition, the human body stimulation unit 10 may have a function of providing a sonic vibration massage on a body. For example, the human body stimulation unit 10 may perform a sonic vibration massage by transmitting sonic vibration to the body of the user through the sonic vibration module 300 disposed at one end portion of the arm 200. Here, the human body stimulation unit 10 may perform a sonic vibration massage on a body and simultaneously drive the arm 200 through the driving unit 100 to physically massage the body through the sonic vibration module 300 disposed at one end portion of the arm 200.

Sonic vibration may be a type of vibration and may refer to vibration generated based on the generation of sound waves. The generation of sonic vibration will be described below. A sonic vibration massage means that sonic vibration is transmitted to the body of the user to obtain a massage effect. When an appropriate sonic vibration massage is performed on the user, the user may obtain effects of improving health, such as effects of lessening a fatigue feeling, improving blood circulation, and relieving stress.

The human body stimulation unit 10 may be movable to massage a body at a various positions. For example, the human body stimulation unit 10 may include the driving unit 100 to move along the backrest 20 of the human body stimulation device 1 and massage a back of the user at various positions.

The human body stimulation device 1 may include a controller 600 (not shown) which controls each component of the human body stimulation device 1 or processes and calculates various types of information. For example, the controller 600 may be included in the human body stimulation unit 10 to control the human body stimulation unit 10 to provide a massage.

The controller 600 may be provided in the form of an electronic circuit which physically processes an electrical signal. The controller 600 may be a concept physically including a plurality of controller 600 as well as a single controller 600. For example, the controller 600 may be provided as one or more processors mounted on one computing device.

Examples of the controller 600 may include a central processing unit (CPU), a graphics processing unit (GPU), a digital signal processor (DSP), a state machine, an application specific integrated circuit (ASIC), a radio-frequency integrated circuit (RFIC), and a combination thereof.

However, the human body stimulation device 1 shown in FIG. 1 is merely an example for convenience of description, and the present invention is not limited thereto. For example, the human body stimulation unit 10 may be installed at any one of other positions, such as the seat 30 and the arm/leg unit 40 instead of the backrest 20. According to some embodiments, components may be added to or excluded from the human body stimulation device 1 of FIG. 1 and may also be subdivided. For example, the human body stimulation device 1 according to one embodiment may further include an operation unit which receives a user input, a display unit which displays a picture or an image, and a speaker which outputs sound.

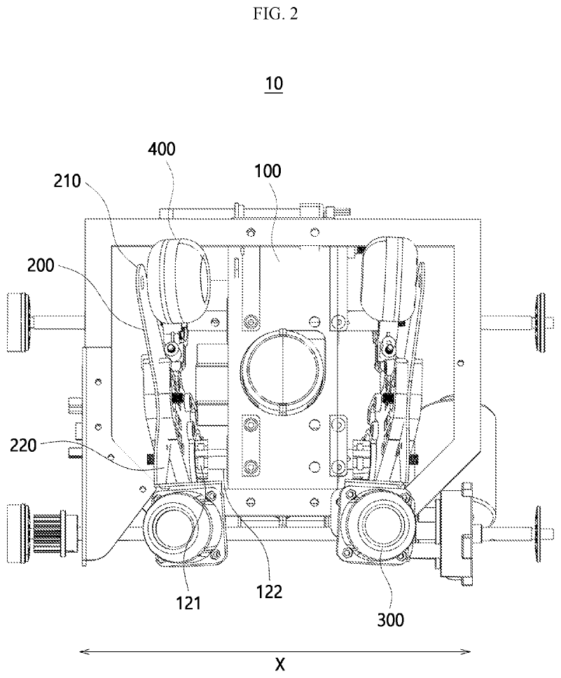

Hereinafter, a human body stimulation unit 10 according to one embodiment will be described with reference to FIGS. 2 to 5.

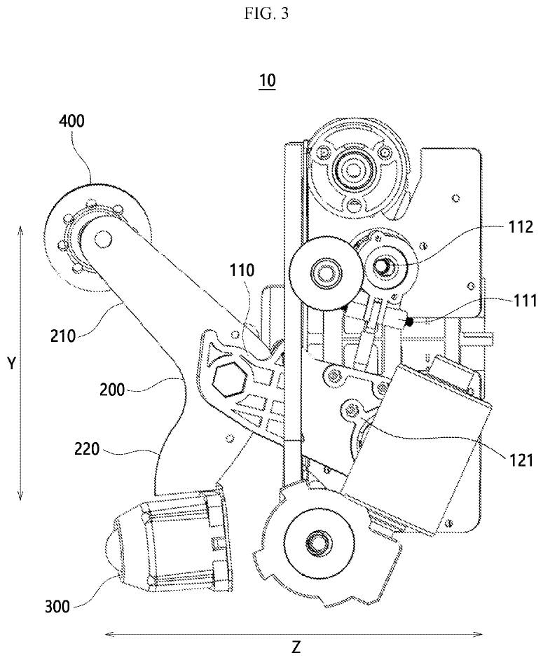

FIG. 2 is a front view of a human body stimulation unit 10 according to one embodiment, and FIG. 3 is a side view of the human body stimulation unit 10 according to one embodiment.

Referring to FIGS. 2 and 3, the human body stimulation unit 10 according to one embodiment may include a driving unit 100, an arm 200, a sonic vibration module 300, and a massage ball.

The driving unit 100 may be configured to move the human body stimulation unit 10 itself. For example, the driving unit 100 may move the human body stimulation unit 10 upward or downward along a guide rail (not shown) installed in a backrest 20. Specifically, the driving unit 100 may allow teeth to be engaged with the guide rail so as to be movable along the guide rail and may rotate the teeth using a lifting motor (not shown) to move the teeth along the guide rail.

In addition the driving unit 100 may be configured to move the components of the human body stimulation unit 10. For example, the driving unit 100 may move the arm 200 in various directions to tap, knead, or press a body. Here, the sonic vibration module 300 and/or a massage ball 400 may be connected to one end portion of the arm 200, may come into contact with a body of a user according to the movement of the arm 200, and may tap or knead the body.

The driving unit 100 may provide a tapping massage to a body by moving the arm 200.

For example, for the tapping massage, the driving unit 100 may include a holder 110 for mounting the arm 200, a link for receiving power from a rotating body 111 to move the holder 110 in a certain route range, and a tapping motor 112 for rotating the rotating body 111. Specifically, the tapping motor 112 may rotate the rotating body 111, a force according to the rotation of the rotating body 111 may be transmitted to the link, and the link may move one end of the connected holder 110 within a certain motion route to move the arm 200. Finally, the sonic vibration module 300 and the massage ball 400 may move the arm 200 forward or backward in a Z-axis direction, may move at a certain motion angle, and may come into contact with a body to tap the body. Here, when a speed of the rotating body 111 increases, a speed of tapping the body may also increase.

The driving unit 100 may provide a kneading massage to a body by moving the arm 200.

For example, for the kneading massage, the driving unit 100 may include a kneading motor 120 (not shown), an eccentric rotating body 121, and a support shaft 122. Specifically, as the kneading motor 120 is driven, the eccentric rotating body 121 installed on the support shaft 122 may rotate eccentrically to move the arm 200 such that the sonic vibration module 300 and the massage ball 400 perform a kneading operation. Here, due to the eccentric rotation of the eccentric rotating body 121, the kneading operation may include all of movement in upward/downward movement in a Y-axis direction, forward/backward movement in the Z-axis direction, and leftward/rightward movement in an X-axis direction so that a route draws a circular motion or an elliptical motion. Accordingly, a contact angle of the massage ball 400 and/or the sonic vibration module 300 in contact with a body may also be changed.

That is, the driving unit 100 may drive the arm 200 to move the sonic vibration module 300 and/or the massage ball 400 within a preset rotation angle range. For example, the sonic vibration module 300 may move along a certain route by changing an inclination angle of a central axis 520 of the sonic vibration module 300. A rotation angle may be an angle inclined while the sonic vibration module 300 and/or the massage ball 400 rotates and moves from an original position thereof and may indicate an angle at which the sonic vibration module 300 and/or the massage ball 400 is inclined by the driving unit 100.

Of course, the driving unit 100 is not limited to the above description and may be driven in other ways.

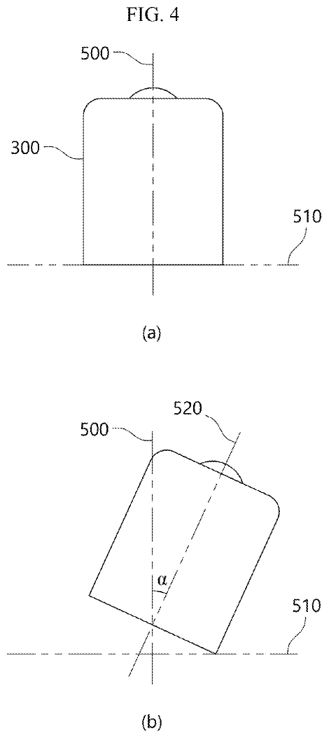

FIG. 4 shows diagrams illustrating an inclination of the sonic vibration module 300 according to one embodiment. Referring to FIG. 4, during a massage, the sonic vibration module 300 may move within a preset rotation angle range through an eccentric movement of the arm 200 connected to the driving unit 100. The sonic vibration module 300 may move within the preset rotation angle range while providing a sonic vibration massage to the body of the user. Through such movement, the sonic vibration module 300 may also provide a general massage such as a kneading massage.

FIG. 4A shows a state in which the sonic vibration module 300 according to one embodiment is at a reference point (original position), and FIG. 4B shows a state in which the sonic vibration module 300 is inclined by a rotation angle α according to one embodiment. Referring to FIGS. 4A and 4B, the rotation angle α may be measured using a reference axis 500.

The reference axis 500 may be the central axis 520 of the sonic vibration module 300 when the sonic vibration module 300 is positioned at the reference point and may be an axis perpendicular to a reference plane 510. The central axis 520 of the sonic vibration module 300 may coincide with the central axis 520 of a head when the head is positioned at an exact center of the sonic vibration module 300. The reference plane 510 may be a floor plane on which the sonic vibration module 300 is supported when the sonic vibration module 300 is positioned at the reference point. The rotation angle α, which is an angle at which the sonic vibration module 300 is inclined, may refer to an angle between the reference axis 500 and the central axis 520 of the sonic vibration module 300.

Therefore, referring to FIG. 4A, when the sonic vibration module 300 is at the original position, the reference axis 500 and the central axis 520 of the sonic vibration module 300 coincide with each other, and thus the rotation angle α at the reference point may be measured as an angle of 0°.

Referring to FIG. 4B, when the sonic vibration module 300 is rotated by the driving unit 100 and positioned at a certain position, the reference axis 500 and the central axis 520 of the sonic vibration module 300 may not coincide with each other at the certain position, and an angle between the reference axis 500 and the central axis 520 of the sonic vibration module 300 at the certain position may be measured as the rotation angle α.

As described above, the rotation angle α may be measured not only by using the sonic vibration module 300 but also by using an angle at which the massage ball 400 or the arm 200 is inclined by the driving unit 100, and the present invention is not limited thereto.

The arm 200 may be connected to the driving unit 100. For example, the arm 200 may be mounted on a driving device through a hinge. Here, the arm 200 may be connected to the driving unit 100, and when the driving unit 100 is driven, the arm 200 may move and come into contact with a body to perform a massage such as tapping or kneading.

The arm 200 may include an upper portion 210 and a lower portion 220 which move in conjunction with each other. For example, as the upper portion 210 approaches the body of the user, the lower portion 220 may also approach the body of the user.

The arm 200 may be connected to the massage ball 400 and/or the sonic vibration module 300. For example, the massage ball 400 may be installed at the upper portion 210 of the arm 200, and the sonic vibration module 300 may be installed at the lower portion 220 of the arm 200. Here, the upper portion 210 of the arm 200 connected to the massage ball 400 may be configured to provide a massage such as tapping or kneading to the body of the user through the massage ball 400, and the lower portion 220 of the arm 200 connected to the sonic vibration module 300 may be configured to provide a sonic vibration massage to the body of the user through the sonic vibration module 300.

Of course, the arm 200 is not limited to the above description. The arm 200 may be connected to the massage ball 400 and/or the sonic vibration module 300 in another form in which the upper portion 210 of the arm 200 is connected to the sonic vibration module 300, and the lower portion 220 of the arm 200 is connected to the massage ball 400.

The sonic vibration module 300 may be an applicator for performing a sonic vibration massage function. For example, the sonic vibration module 300 may generate sonic vibration and may be in direct/indirect contact with a body to transmit the generated sonic vibrations to the body. Here, sonic vibration used for a sonic vibration massage may be sonic vibration in an audible frequency range. Specifically, the sonic vibration used for the sonic vibration massage may have a frequency range of 10 Hz to 300 Hz.

The sonic vibration module 300 may be an applicator for performing a function of a general massage which may be referred to as a motion massage. For example, the sonic vibration module 300 may be connected to the arm 200 and may perform a general massage such as a tapping or kneading massage on the body of the user in synchronization with movement of the arm 200. In the present specification, the term “motion massage” may refer to a generally performed massage and may refer to an act of stimulating a body part such as repeatedly pressing the body part for a certain time or more or shaking the body part.

According to one embodiment, the sonic vibration module 300 may provide a tapping massage, a kneading massage, or the like to a body and simultaneously provide a vibration massage. As an example, a human body stimulation device 1 may provide a multi-massage in which the sonic vibration module 300 outputs sonic vibration to a body while providing a kneading massage by moving the sonic vibration module 300. As another example, the human body stimulation device 1 may provide a multi-massage in which the sonic vibration module 300 outputs sonic vibration to a body while providing a tapping massage by moving the sonic vibration module 300.

According to one embodiment, the sonic vibration module 300 may be installed at the lower portion 220 of the arm 200 and may be installed downward at a certain angle from the arm 200. For example, the sonic vibration module 300 may be installed downward at an angle of 5° to 20° from the arm 200.

This is to prevent contact between the head of the sonic vibration module 300 and a body from becoming difficult due to the sonic vibration module 300 of the lower portion 220 interlocked with the upper portion 210 being inclined upward from the arm 200 as an applicator of the upper portion 210 of the arm 200 comes into contact with a body of a user to press the body.

The certain angle may be related to movement of the lower portion 220 when the sonic vibration module 300 is moved by the driving unit 100. For example, the certain angle may be related to an angle at which the lower portion 220 is inclined when the sonic vibration module 300 is moved forward to or backward from the body of the user by the driving unit 100. Here, when the sonic vibration module 300 is moved forward to or backward from the body of the user by the driving unit 100, as an angle at which the lower portion 220 is inclined is increased, the certain angle may also be increased. Of course, the certain angle is related not only to an angle at which the lower portion 220 is inclined by the driving unit 100 but also to a position of the lower portion 220 being changed as the sonic vibration module 300 is moved forward or backward, but the present invention is not limited thereto.

Thus, it is possible to assist the sonic vibration module 300 in maintaining body contact during a massage, increase a life time of the human body stimulation device 1 by preventing the sonic vibration module 300 from performing an idle operation, also reduce noise generation, and continuously provide a vibration massage to a body.

The sonic vibration module 300 will be described in detail below.

The massage ball 400 may be an applicator for performing a general massage function. For example, the massage ball 400 may be connected to the arm 200 and may perform a general massage such as a tapping or kneading massage on the body of the user in synchronization with the movement of the arm 200.

The massage ball 400 may have a shape, material, or the like for performing a massage. For example, the massage ball 400 may have a curved shape and may have an elliptical shape or a spherical shape in a plan view. For another example, the massage ball 400 may be made of an elastic material such as rubber or silicone for a soft massage.

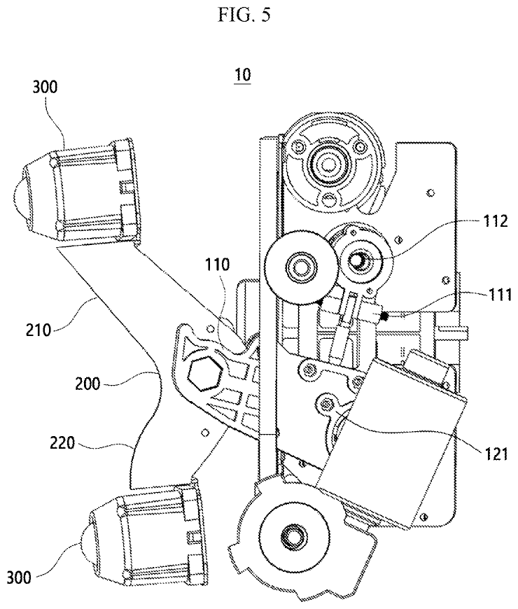

Of course, the human body stimulation unit 10 is not limited to that described above with reference to FIG. 3 and may be implemented in other forms. As an example, the human body stimulation unit 10 may be implemented as shown in FIG. 5. FIG. 5 is a view illustrating a human body stimulation unit 10 according to another embodiment. Referring to FIG. 5, the human body stimulation unit 10 according to one embodiment may include a sonic vibration module 300 instead of a massage ball 400. Here, the human body stimulation unit 10 may provide a general massage as well as a sonic vibration massage to a user using only the sonic vibration module 300.

The human body stimulation unit 10 is not limited to the above description, and the sonic vibration module 300 may be implemented in another form without being mounted on an arm 200.

As an example, the sonic vibration module 300 may be mounted on a base of the human body stimulation unit 10. Here, the sonic vibration module 300 may not move through the arm 200 but may move by using an air bag connected to the sonic vibration module 300. Specifically, air may be injected into the airbag connected to the sonic vibration module 300 so that the sonic vibration module 300 may come into contact with a body of a user, or a direction of the airbag may be changed so that the sonic vibration module 300 may move within a preset rotation angle range. As another example, the sonic vibration module 300 may be installed inside an airbag installed in the human body stimulation unit 10.

According to some embodiments, components may be added to or excluded from the human body stimulation unit 10 of FIGS. 2 to 5 and may also be subdivided. As an example, the human body stimulation unit 10 may include an X-axis motor for allowing an applicator for a massage to reciprocate in an X-axis direction, a Y-axis motor for allowing the applicator to reciprocate in a Y-axis direction, and a Z-axis motor for allowing the applicator to reciprocate in a Z-axis direction. Here, the human body stimulation unit 10 may provide a tapping massage and/or a kneading massage by combining reciprocating motions in the X-axis, Y-axis, and Z-axis directions.

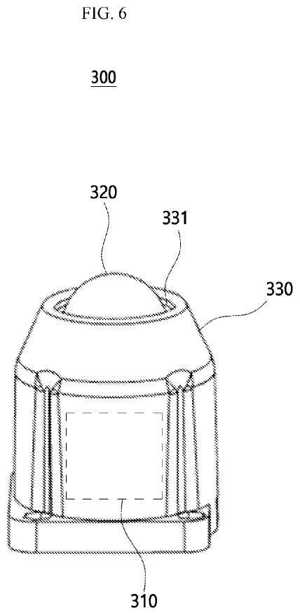

A sonic vibration module 300 will be described with reference to FIGS. 6 to 9.

FIG. 6 is a view illustrating the sonic vibration module 300 according to one embodiment. Referring to FIG. 6, the sonic vibration module 300 may include a sonic vibration generator 310, a head 320, and a housing 330. The sonic vibration module 300 may generate sonic vibration through the sonic vibration generator 310 and may transmit the generated sonic vibration to a body of a user through the head 320 connected to a sonic vibration unit.

The sonic vibration generator 310 may generate sonic vibration. For example, the sonic vibration generator 310 may include devices (not shown) for reproducing a sound source therein, for example, a codec, an amplifier, and a speaker, and may generate vibration using a sound source. Here, the sonic vibration generator 310 may output sonic vibration corresponding to a sound source. The sonic vibration generator 310 will be described in detail below.

The head 320 may transmit the generated sonic vibration to the body of the user. For example, the head 320 may be connected to the sonic vibration generator 310 and may transmit the sonic vibration transmitted from the sonic vibration generator 310 to the body of the user in direct/indirect contact therewith. Here, the head 320 may be made of various materials, for example, a silicone material, a wood material, a plastic material, and a metal material. The head 320 may transmit stronger sonic vibration to the user by locally transmitting the sonic vibration to the body of user.

The housing 330 may accommodate the sonic vibration generator 310. For example, the housing 330 may surround the sonic vibration generator 310 therein and may prevent an external force due to a massage from being applied to the sonic vibration generator 310. Thus, the durability of the sonic vibration module 300 can be improved.

The housing 330 may at least partially accommodate the head 320. For example, the housing 330 may surround a portion of the head 320 connected to the sonic vibration generator 310 and may expose a portion of the head 320 through a pierced hole such that the head 320 may be in direct/indirect contact with the body of the user. Since the housing 330 exposes only a portion of the head 320, the housing 330 may prevent the head from being tilted and damaged due to an external force applied from a side surface of the head 320.

The housing 330 may be implemented in various shapes. For example, a portion of the housing 330 in contact with a body may be provided as a round surface to be in smooth contact with the body. Here, a hole through which the head 320 passes may be formed in the housing 330 such that a portion of the head 320 may be exposed to the outside. Specifically, in order to prevent the head 320 from being heavily tilted due to an external force, a buffer member 331 made of a silicone material or the like may be provided in a space between the head 320 and the hole of the housing 330.

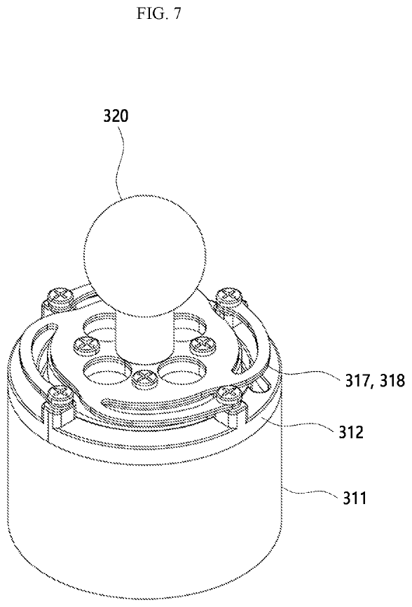

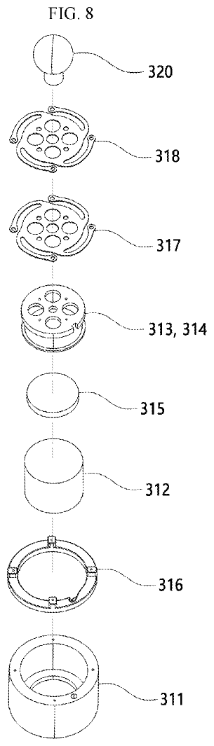

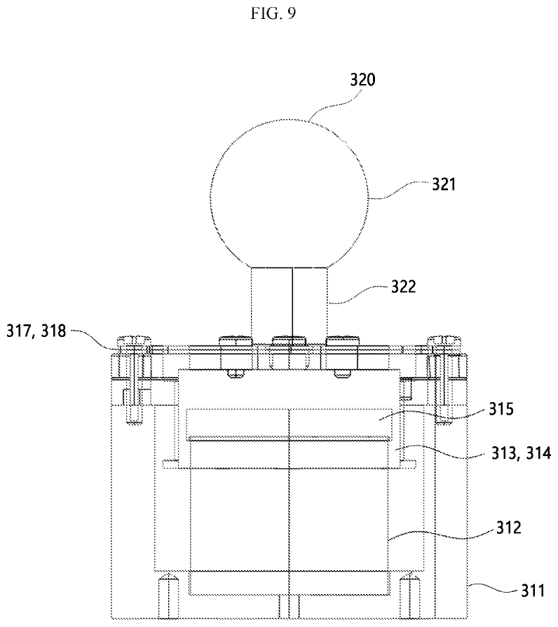

FIG. 7 is a view illustrating the head 320 and the sonic vibration generator 310 of the sonic vibration module 300 according to one embodiment. FIG. 8 is an exploded perspective view illustrating the head 320 and the sonic vibration generator 310 according to one embodiment. FIG. 9 is a cross-sectional view illustrating the head 320 and the sonic vibration generator 310 according to one embodiment.

Referring to FIGS. 7 to 9, the sonic vibration module 300 according to one embodiment may include a lower plate 311, a magnetic body 312, a bobbin 313, a coil 314, a middle plate 315, an upper ring 316, a first leaf spring 317, a second leaf spring 318, and the head 320.

The lower plate 311 may have a space, in which the magnetic body 312 is accommodated, formed therein. For example, the lower plate 311 may have a cylindrical shape with an open upper portion, and the magnetic body 312 may be installed therein. The lower plate 311 may be used to form a magnetic path of a magnetic field formed by the magnetic body 312 and the coil 314.

The magnetic body 312 may be installed inside the lower plate 311 to be spaced apart from the lower plate 311. For example, a groove, in which the magnetic body 312 is fixedly installed, may be formed in a bottom surface of the lower plate 311, and an inner surface of the lower plate 311 may be spaced a certain interval apart from an outer peripheral surface of the magnetic body 312 installed in the groove.

The magnetic body 312 may be, for example, a permanent magnet that is a ferromagnetic body such as a neodymium magnet. When power is applied to the sonic vibration module 300 to magnetize the coil 314, the magnetic body 312 may be used to generate an attractive force and a repulsive force and generate vibration. Here, the magnetic body 312 may be positioned in a lower surface of the bobbin 313, and when the coil 314 wound on the bobbin 313 is magnetized, the magnetic body 312 may generate an efficient magnetic field to generate a mutual attractive force and a repulsive force and generate stable vibration.

The middle plate 315 may be installed on the magnetic body 312 to prevent loss of a magnetic field generated by the magnetic body 312. For example, the middle plate 315 may have a shape similar to that of an upper surface of the magnetic body 312 and may be installed between an upper portion of the magnetic body 312 and a lower portion of the bobbin 313 to induce a magnetic force of the magnetic body 312 to be concentrated on the coil 314. Here, a magnetic fluid (not shown) may be applied to an outer diameter portion of the middle plate 315 to form a magnetic field.

The bobbin 313 may be made of a material not having magnetism (for example, aluminum material or the like) and may be installed inside the lower plate 311. For example, the bobbin 313 may be installed inside the lower plate 311 in a state in which the voice coil 314 is wound thereon. The bobbin 313 may correct physical eccentricity generated due to body contact.

The bobbin 313 is formed in a cylindrical shape of which a side surface is open between an upper portion and a lower portion. A radius of an upper surface and a lower surface of the bobbin 313 may be greater than a radius of the side surface thereof, and the lower portion of the side surface may extend outward so that the bobbin 313 may include the lower surface facing the upper surface. Here, the coil 314 may be wound on the side surface of the bobbin 313, and the coil 314 may be guided by the upper surface and the lower surface of the bobbin 313 having the radius greater than the radius of the side surface of the bobbin 313. Thus, the bobbin 313 may guide the coil 314 to be stably installed at an outer peripheral portion thereof, thereby preventing the coil 314 from being separated.

The bobbin 313 may be connected to the head 320. For example, the bobbin 313 may be coupled to the head 320 through a coupling hole formed in a central portion of the upper surface thereof.

The bobbin 313 may include a heat radiation hole for radiating heat. For example, the bobbin 313 may radiate generated when vibration is generated through one or more heat radiation holes formed in the upper surface thereof and may reduce noise generated, when vibration is generated, together with a heat radiation effect.

The upper ring 316 may be disposed on the lower plate 311 and may be coupled to the first leaf spring 317 and the second leaf spring 318. For example, the upper ring 316 may be coupled to the first leaf spring 317 and the second leaf spring 318 through a plurality of coupling protrusions formed on an upper surface thereof. Here, the coupling protrusions may be coupled to dampers formed in the first and second leaf springs 317 and 318. In addition, upper and lower portions of the coupling protrusion coupled to the damper are supported through an elastic member (for example, a silicone washer or the like), thereby preventing vibration from being attenuated. The upper ring 316 can form a space in which the leaf spring may move upward and downward according to the characteristics of generated sonic vibration so that the durability of the sonic vibration module 300 can be improved.

The leaf springs 317 and 318 may be installed on the bobbin 313. For example, the leaf springs 317 and 318 may be installed on the bobbin 313 and may act like a speaker to generate vibration when a sound source is applied. Specifically, the leaf springs 317 and 318 may generate sonic vibration in a vertical direction using a magnetic field generated by an interaction between the magnetic body 312 and the coil 314.

The leaf springs 317 and 318 may be made of various materials suitable for generating sonic vibration. As an example, the leaf springs 317 and 318 may be made of a metal material such as copper or STS301.

The leaf springs 317 and 318 may have the dampers formed at an edge thereof to maximize a vibration force. For example, the leaf springs 517 and 518 may include one or more dampers which are formed in a shape elongated radially in a shape of a curved band at the edge thereof and which have coupling holes for screw coupling formed in end portions thereof. Here, the dampers may be coupled to the coupling protrusions of the upper ring 316 through the coupling holes. Of course, the shape of the damper is not limited thereto, and as an example, the damper may be formed in various ways in which an outer peripheral portion of the damper is formed in a circular structure and the end portion of the damper is disposed between fixing points.

The leaf springs 317 and 318 may include heat radiation holes for radiating heat. For example, the leaf springs 317 and 318 may radiate heat generated when vibration is generated through one or more heat radiation holes formed in an upper surface thereof and may reduce noise that is generated, when vibration is generated, together with a heat radiation effect.

The leaf springs 317 and 318 may transmit generated vibration to the outside. For example, the leaf springs 317 and 318 may be connected to the head 320 and may transmit generated sonic vibration to the head 320. Here, since sonic vibration generated in central portions of the leaf springs 317 and 318 is the strongest, the leaf springs 317 and 318 may be coupled to the head 320 through coupling holes formed in the central portions of the leaf springs 317 and 318, thereby transmitting the generated sonic vibration to the head 320.

The leaf springs 317 and 318 may be installed doubly on the bobbin 313 to improve durability. For example, the first leaf spring 317 and the second leaf spring 318 may be installed to overlap each other on the bobbin 513, but the present invention is not limited thereto. The first leaf spring 517 and the second leaf spring 518 may be installed apart from each other by a certain distance. In addition, the first leaf spring 317 and the second leaf spring 318 may be implemented to have the same material and/or shape, but the present invention is not limited thereto. The first leaf spring 317 and the second leaf spring 318 may be implemented to have different materials and/or shapes. In addition, the leaf springs 317 and 318 are not limited to the above description and may be implemented as one leaf spring without being doubly installed.

The head 320 may receive the generated vibration to transmit the vibration to the outside. For example, the head 320 may be connected to the leaf springs 317 and 318 and the bobbin 313 and may receive sonic vibration generated from the leaf springs 317 and 318 and/or the bobbin 313 to transmit the received sonic vibration to the body of the user in direct/indirect contact therewith. Specifically, a lower portion 322 of the head 320 may be inserted into the coupling holes formed in the leaf springs 317 and 318 and the coupling hole formed in the bobbin 313 and coupled to the leaf springs 317 and 318 and/or the bobbin 313. Here, a structure to be screw-coupled to the head 320 may be formed inside the coupling holes. Therefore, since the head 320 is connected to the leaf springs 317 and 318, when the leaf springs 317 and 318 generate vibration in the vertical direction by acoustic pressure, the head 320 may transmit the vibration to a body.

The head 320 may have various shapes according to a massage part or a stimulation part of a body or purpose of use. For example, the head 320 may be provided in various shapes such as a plate shape, a plate shape having protrusions, a cylindrical shape, a rectangular parallelepiped shape, and a spherical shape according to a massage part and a purpose of a massage.

According to one embodiment, the head 320 may include the lower portion 322 and an upper portion 321 of the head 320. For example, the lower portion 322 and the upper portion 321 of the head 320 may be integrally formed, the lower portion may serve as a connection portion that connects the upper portion and the sonic vibration generator 310, and the upper portion may serve as a hitting portion that applies vibration. Specifically, the lower portion 322 of the head 320 may be connected to the sonic vibration generator 310, and sonic vibration generated from the sonic vibration generator 310 may be transmitted to the upper portion 321 of the head 320. The upper portion 321 of the head 320 may apply the received sonic vibration to the body of the user.

As an example, the upper portion 321 of the head 320 is formed in a shape with a round surface including a spherical or hemispherical shape, and the lower portion 322 of the head 320 may be formed in a cylindrical shape to be inserted into the coupling holes formed in the leaf springs 317 and 318 and the coupling hole formed in the bobbin 313. However, the shape of the head 320 is not limited thereto, and as an example, the upper portion 321 of the head 320 may be implemented in various shapes such as a plate shape or a plate shape having protrusions formed thereon. However, the lower portion 322 and the upper portion 321 of the head 320 are not limited to the above description and may be implemented in other forms.

The head 320 may have a detachable structure. For example, the head 320 may include a coupling portion that is attachable to or detachable from the leaf springs 317 and 318 and may be replaced with another head 320 through the coupling portion.

In addition, although not shown, the sonic vibration module 300 may include a connection member, and the connection member may be connected to the bobbin 313 and disposed on the leaf springs 317 and 318 to serve to facilitate the attachment or detachment of various heads 320.

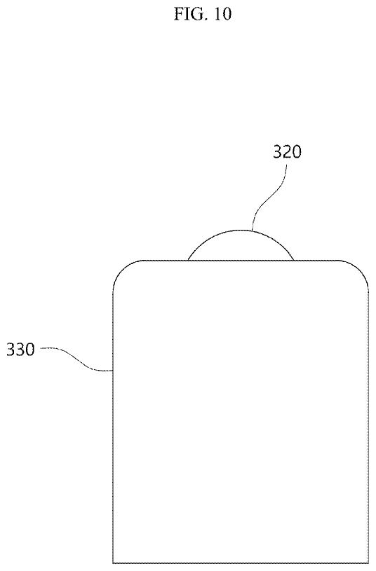

FIG. 10 is a front view illustrating the sonic vibration module 300 according to one embodiment.

Referring to FIG. 10, a portion of the head 320 may be positioned inside the housing 330, and another portion of the head 320 may be exposed from the housing 330.

The housing 330 may be in contact with the body of the user to prevent an external force from being excessively applied to the sonic vibration generator 310 positioned therein due to a massage. Specifically, when an external force is applied to the sonic vibration module 300, the leaf springs 317 and 318 and the bobbin 313 are pushed downward by the external force, and thus the head 320 is also pushed downward. In this case, the housing 330 may disperse the external force and may prevent the head 320 from being lowered by a certain level or more.

In addition, the housing 330 may prevent the head 320 from being excessively tilted and damaged due to an external force applied from a side surface of the head 320. Here, a portion of the housing 330 in contact with a body may be provided as a round surface to be in smooth contact with the body.

The exposed portion of the head 320 may be in direct/indirect contact with the body of the user and may transmit vibration to the body of the user. The head 320 may locally transmit sonic vibration to the body to improve an effect of a sonic vibration massage.

However, when the head 320 is not sufficiently exposed from the housing 330, a movement range of the sonic vibration module 300, which moves in a state in which contact between the head 320 and the body of the user is maintained, may be excessively limited, and vibrations may not be sufficiently transmitted to the body of the user. In addition, when the head 320 is excessively exposed from the housing 330, the head 320 may be excessively inclined by an external force applied from the side surface of the head 320, which may cause damage to the sonic vibration module 300.

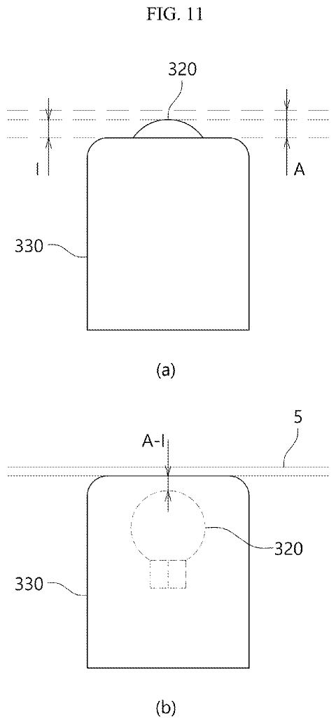

FIG. 11 shows diagrams for describing a maximum exposure degree of the head 320 of the sonic vibration module 300 according to one embodiment. Referring to FIG. 11, since vibration generated by the sonic vibration module 300 is vibration in a vertical direction, a length of a portion of the head 320, which is exposed from the housing 330, may be formed in consideration of a maximum amplitude. Thus, the human body stimulation device 1 can effectively provide a vibration massage at the same time while moving the sonic vibration module 300. As an example, the human body stimulation device 1 may provide a motion massage to a body 5 through the sonic vibration module 300 and effectively provide a vibration massage at the same time.

Referring to FIG. 11A, an exposure length 1 of the head 320 may be designed to be less than a maximum amplitude A of vibration output from the sonic vibration module 300. That is, as shown in FIG. 11B, even when the head 320 comes into contact with a body 5 to be pressed by the exposure length l by pressure applied thereto, vibration having a minimum amplitude of A−1 may be transmitted. When the exposure length of the head 320 is greater than the maximum amplitude of the vibration output from the sonic vibration module 300, due to contact with the body 5, the head 320 may be pressed. Even when the pressed head 320 is vibrated at the maximum amplitude, vibration cannot be substantially transmitted to the body 5.

For example, when the maximum amplitude A of the vibration output from the sonic vibration module 300 is 3 mm and the exposure length l of the head 320 is 2 mm, a vertical movement range of the head 320 may be in a range of −1 mm to 5 mm with respect to a reference line. Here, when an external force is applied to the sonic vibration module 300 due to a tapping massage being performed using the sonic vibration module 300, even when the head 320 is pressed by 2 mm by pressure applied thereto, the head 320 may vibrate between 0 mm and −1 mm with respect to the reference line, and thus vibration having an amplitude of at least 1 mm may be transmitted to the body 5 of the user.

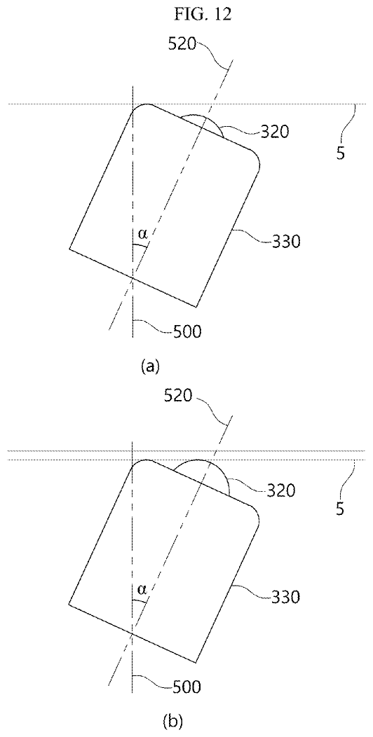

FIG. 12 shows views for describing that whether the head 320 is in contact with the body 5 is changed according to an exposure degree of the head 320 according to one embodiment. Referring to FIG. 12A, in a case in which the head 320 is exposed too little, when the sonic vibration module 300 moves by a rotation angle α, the head 320 may not come into contact with the body 5 of the user. Referring to FIG. 12B, in a case in which the head 320 is exposed sufficiently, even when the sonic vibration module 300 moves by the same rotation angle α, the head 320 may come into contact with the body 5 of the user.

Therefore, while the sonic vibration module 300 moves in a preset rotation angle range, the human body stimulation unit 10 may be designed such that the exposed portion of the head 320 is formed such that the head 320 may come into contact the body 5 of the user even at any position.

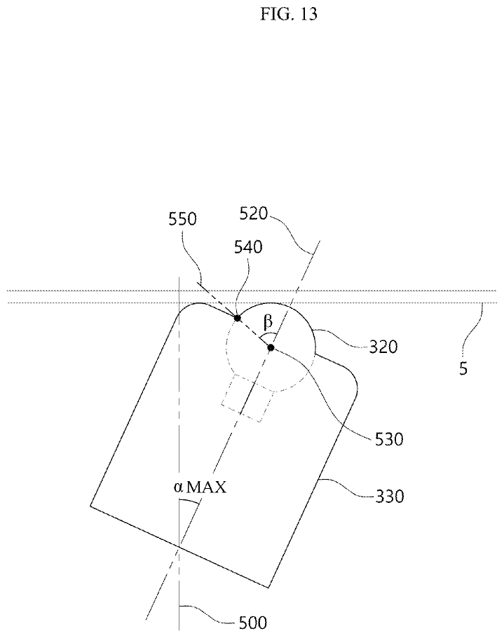

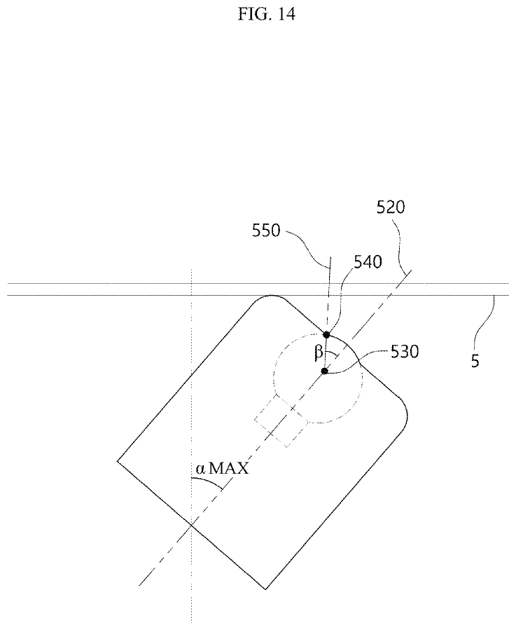

FIGS. 13 and 14 are diagrams for describing a relationship between a rotation angle at which the sonic vibration module 300 moves and a solid angle of an exposed portion of the head 320 according to one embodiment. Referring to FIGS. 13 and 14, while the sonic vibration module 300 moves in a preset rotation angle range, a portion of the head 320 exposed from the housing 330 may be designed in consideration of a rotation angle in a radius at which the sonic vibration module 300 moves such that the head 320 may come into contact the body 5 of the user even at any position. Thus, while the human body stimulation device 1 moves the sonic vibration module 300, the human body stimulation device 1 may effectively provide a vibration massage at the same time. As an example, while the human body stimulation device 1 provides a motion massage to the body 5 through the sonic vibration module 300, the human body stimulation device 1 may effectively provide a vibration massage at the same time.

Referring to FIG. 13, the exposed portion of the head 320 according to one embodiment may have a solid angle β that is greater than a maximum rotation angle αmax in a preset rotation angle range at which the sonic vibration module 300 moves. The solid angle β may be defined as an angle between the central axis 520 of the head 320 and an imaginary line 550 formed between a central point 530 of the upper portion 321 of the head 320 and a point 540 at which the exposed portion starts to be exposed from the housing 330. When the head 320 is installed such that the solid angle β is greater than the maximum rotation angle αmax in the radius at which the sonic vibration module 300 moves, even when the sonic vibration module 300 moves in the preset rotation angle range during a massage, at least a portion of the head 320 may continuously maintain contact with the body 5.

For example, when a maximum rotation angle at which the sonic vibration module 300 moves during a kneading operation is 45°, the exposed portion of the head 320 may have a solid angle of 80° that is greater than 45°. Here, as the solid angle of the exposed portion of the head 320 increases, a contact area with the body 5 may increase when the sonic vibration module 300 is inclined at the maximum rotation angle αmax. However, the head 320 may be tilted by an external force due to contact with the body 5, and thus a risk of damage to the sonic vibration module 300 may be further increased.

According to one embodiment, the exposed portion of the head 320 may be formed in consideration of a position of the head 320 which vertically moves due to sonic vibration. For example, while sonic vibration is generated, the solid angle β may be changed between a minimum solid angle and a maximum solid angle, and the minimum solid angle may be set to be greater than the maximum rotation angle αmax such that the head 320 is in continuous contact with the body of the user while the sonic vibration is generated.

Referring to FIG. 14, when the exposed portion of the head 320 has the solid angle β that is less than the maximum rotation angle αmax in the preset rotation angle range at which the sonic vibration module 300 moves, since the exposure of the head 320 is too small, it may be difficult for the head 320 to come into contact with the body 5 of the user.

In FIGS. 13 and 14, a shape of the head 320 is illustrated as being a spherical shape, but the present invention is not limited thereto. For example, the head 320 may be applied to a case in which the shape of the head 320 is variously implemented such as being implemented as a square shape.

According to one embodiment, the head 320 of the sonic vibration module 300 may be exposed by a length that is less than a maximum amplitude of vibration output from the sonic vibration module 300 and may be designed to be exposed such that the solid angle of the head 320 is greater than the maximum rotation angle at which the sonic vibration module 300 moves. Thus, when a tapping massage is provided using the sonic vibration module 300, it is possible to prevent excessive damage to the sonic vibration module 300, and when a kneading massage is provided, it is possible to prevent a decrease in efficiency in which the sonic vibration module 300 applies sonic vibration to the body 5.

Therefore, it is possible to increase a life time of the human body stimulation device 1 by preventing the sonic vibration module 300 from performing an idle operation, also reduce noise generation, and continuously provide a vibration massage to the body 5.

The formation of the exposed portion of the head 320 is not limited to the above description, and the exposed portion of the head 320 may be implemented differently such as being formed in consideration of the shape, size, and length of the housing, and the shape, size, and length of the head.

The description above is merely illustrating the technical spirit of the present invention, and various changes and modifications may be made by those skilled in the art without departing from the essential characteristics of the present invention. Therefore, the embodiments of the present specification described above may be implemented separately or in combination with each other.

Therefore, the embodiments disclosed in the present specification do not limit but describe the technical idea of the present invention, and the scope of the technical idea of the present invention is not limited by the embodiments. The scope of the present invention shall be interpreted on the basis of the accompanying claims, and it should be interpreted that all of the technical ideas included within the scope equivalent to the claims belong to the scope of the present invention.

What is claimed is:

1. A human body stimulation unit for providing a sonic vibration massage to a body of a user, the human body stimulation unit comprising:
a sonic vibration module configured to provide the sonic vibration massage;
an arm connected to one end portion of the sonic vibration module to support the sonic vibration module; and
a driving unit which drives the arm to move the sonic vibration module within a preset rotation angle range,
wherein:
the sonic vibration module includes a housing, a sonic vibration generator configured to generate sonic vibration inside the housing, and a head connected to the sonic vibration generator and configured to transmit the generated sonic vibration to the body of the user in order for the sonic vibration massage;
the housing partially surrounds the head to expose a portion of an upper portion of the head from the housing; and
the exposed portion of the head is formed such that the head comes into contact with the body of the user even when the sonic vibration module is positioned at a maximum rotation angle in the preset rotation angle range.

2. The human body stimulation unit of claim 1, wherein:
the exposed portion of the head has a solid angle that is greater than the maximum rotation angle in the preset rotation angle range; and
the solid angle is defined as an angle between a central axis of the head and an imaginary line formed between a central point of the upper portion of the head and a point at which the exposed portion starts to be exposed from the housing.

3. The human body stimulation unit of claim 2, wherein:
while the sonic vibration is generated, the solid angle is changed between a minimum solid angle and a maximum solid angle; and
the minimum solid angle is set to be greater than the maximum rotation angle such that the head is in continuous contact with the body of the user while the sonic vibration is generated.

4. The human body stimulation unit of claim 1, wherein a length of the exposed portion is formed based on an amplitude of the sonic vibration massage.

5. The human body stimulation unit of claim 4, wherein the length of the exposed portion is less than a maximum amplitude of the sonic vibration massage.

6. The human body stimulation unit of claim 1, wherein:
a lower portion of the head is connected to the sonic vibration generator and transmits the sonic vibration generated from the sonic vibration generator to the upper portion of the head; and
the upper portion of the head applies the received sonic vibration to the body of the user.

7. The human body stimulation unit of claim 1, wherein the upper portion of the head is formed in a shape having a round surface including a spherical shape or a hemispherical shape.

8. The human body stimulation unit of claim 1, wherein a front surface portion of the housing has a round surface.

9. The human body stimulation unit of claim 1, wherein:
the arm includes an upper portion and a lower portion which move in conjunction with each other;
a massage ball or the sonic vibration module is installed at the upper portion; and
the sonic vibration module is installed at the lower portion.

10. The human body stimulation unit of claim 9, wherein the sonic vibration module installed at the lower portion is installed downward at a certain angle from the arm.

11. The human body stimulation unit of claim 10, wherein the certain angle is related to an angle at which the lower portion is inclined when the sonic vibration module installed at the lower portion is moved forward to or backward from the body of the user by the driving part.

12. The human body stimulation unit of claim 10, wherein the certain angle is in a range of 5° to 20°.

13. A chair-type human body stimulation device, a bed-type human body stimulation device, or a sofa-type human body stimulation device comprising a human body stimulation unit, the human body simulation unit comprising:
a sonic vibration module configured to provide the sonic vibration massage;
an arm connected to one end portion of the sonic vibration module to support the sonic vibration module; and
a driving unit which drives the arm to move the sonic vibration module within a preset rotation angle range,
wherein:
the sonic vibration module includes a housing, a sonic vibration generator configured to generate sonic vibration inside the housing, and a head connected to the sonic vibration generator and configured to transmit the generated sonic vibration to the body of the user in order for the sonic vibration massage;
the housing partially surrounds the head to expose a portion of an upper portion of the head from the housing; and
the exposed portion of the head is formed such that the head comes into contact with the body of the user even when the sonic vibration module is positioned at a maximum rotation angle in the preset rotation angle range.
